(19) United States
(12) Patent Application Publication
(10) Pub. No.: US 2016/0201643 A1
(43) Pub. Date: Jul. 14, 2016

(54) Portable Hydroelectric Generator

(71) Applicant: Milton Blake, Bridegport, CT (US)

(72) Inventor: Milton Blake, Bridegport, CT (US)

(21) Appl. No.: 14/991,570

(22) Filed: Jan. 8, 2016

Related U.S. Application Data
(60) Provisional application No. 62/100,961, filed on Jan. 8, 2015.

(51) Int. Cl. F03B 17/06; H02K 11/00; H02K 7/02

(52) U.S. Cl. CPC F03B 17/06; H02K 7/02; H02K 11/0094; Y10S 415/916; F03B 17/005

(57) ABSTRACT

A portable hydroelectric generator. The portable hydroelectric generator includes a flywheel adapted to rotate from a flow of water, turning a driveshaft and powering a generator. The flywheel is brought to an initial rotational speed from an external power source or from electricity stored in the battery. The flywheel rotation is maintained with a flow of water from a pump which moves water from the bottom of the housing to the blades of the flywheel. The rotation from the flywheel to the generator produces electricity. The generated electricity is stored in a battery, which provides power to an outlet as well as to the pump. Additionally, the generator can include a solar panel to provide an alternative source of power for the initial rotation of the flywheel.

### CROSS REFERENCE TO RELATED APPLICATIONS

This application claims the benefit of U.S. Provisional Application No. 62/100,961 filed on Jan. 8, 2015. The above identified patent application is herein incorporated by reference in its entirety to provide continuity of disclosure.

### BACKGROUND OF THE INVENTION

The present invention relates to electric generators. More specifically, the present invention relates to portable electric generators that are powered by water pressure and provide a convenient means of connecting and powering electrical items.

The use of water to create electricity is common and widespread. Many large scale power plants rely on the potential energy of water stored in dams to power hydroelectric turbines. These power plants use the gravitational pull on large quantities of water to turn massive turbines and power electricity-producing generators. While dams and gravity are well suited for industrial-sized power generation, they are unfit and cumbersome for use in smaller scale projects.

Smaller generators are useful and often essential when access to conventional power sources is limited. They can be used recreationally, such as to power camping gear and electric tools, as well as for backup purposes to ensure that a home or business can continue receiving power. Having access to a working generator can be essential when disaster hits, from powering water pumps for draining floodwater to charging cell phones and personal computers, enabling important communication. Many of the personal generators currently available are powered by non-renewable petroleum by-products, such as gasoline, natural gas, diesel and liquid propane.

While these generators can produce power efficiently, they have a number of significant drawbacks. They require access to sufficient fuel, which can often only be provided in a limited capacity in order to maintain the true portable nature of the generator. Additionally, these small generators can only be used safely in a space with proper ventilation for the exhaust fumes of the combusted fuel. Furthermore, many of the portable generators currently available are heavy and cumbersome, hindering the portability of the generator. In light of these disadvantages in the prior art, there is a need for a portable generator that is small, light, and safe that can be used to generate electricity in situations where access to fuel and clear ventilation is limited.

### SUMMARY OF THE INVENTION

In view of the foregoing disadvantages inherent in the known types of hydroelectric generators now present in the prior art, the present invention provides a portable hydroelectric generator wherein the same can be utilized for providing convenience for the user in providing a source of electricity using a commonly accessible liquid such as water.

The present system comprises a housing, a flywheel with blades attached thereto, an electric generator, a driveshaft connecting the flywheel to the electric generator, a pump, a battery and an electric outlet. The housing is partially filled with a liquid such as water. The pump carries the water from the bottom of the housing to an output location near the flywheel blades. The water is discharged, creating a flow that applies a force to the flywheel blades. The flywheel rotates, turning the driveshaft, which in turn rotates the generator, creating electricity. The generator charges the battery, which stores the electricity for use. Both the outlet and the pump draw power from the battery. The flywheel is configured to maintain sufficient angular momentum to power the electric generator. There can be an external mechanical force such as a manual lever or an electrical source such as a solar panel or external power supply to begin the flywheel rotation from its resting position.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable hydroelectric generator.

FIG. 2 shows an alternative perspective view of an embodiment of the portable hydroelectric generator.

FIG. 3 shows a perspective view of an alternative embodiment of the portable hydroelectric generator.

FIG. 4 shows a rear perspective view of an alternative embodiment of the portable hydroelectric generator.

### DETAILED DESCRIPTION OF THE INVENTION

Reference is made herein to the attached drawings. Like reference numerals are used throughout the drawings to depict like or similar elements of the portable hydroelectric generator. The figures are intended for representative purposes only and should not be considered to be limiting in any respect.

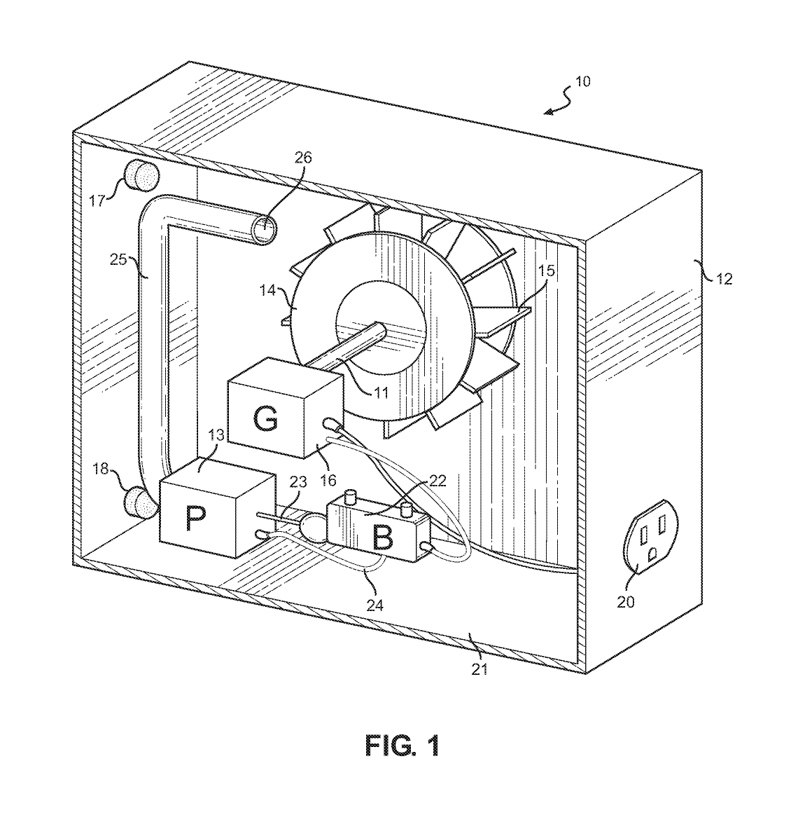

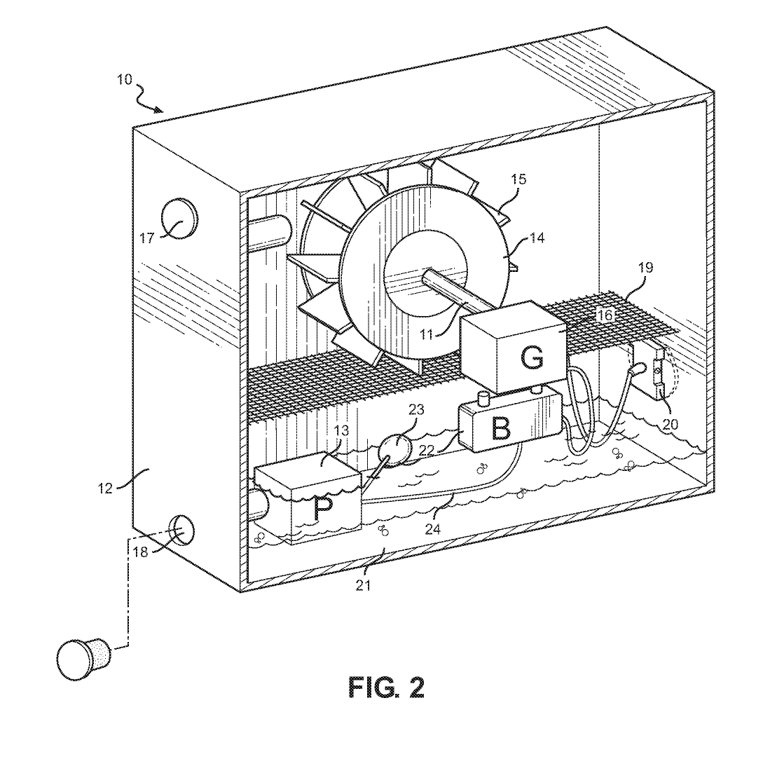

Referring now to FIGS. 1 and 2, there are shown perspective views of an embodiment of the portable hydroelectric generator. The portable hydroelectric generator 10 comprises a housing 12 having sidewalls defining an interior volume. The housing 12 contains a pump 13 having an input port and an output port 26, a flywheel 14 comprised of a central wheel with blades 15 extending therefrom, an electric generator 16 known in the prior art, a driveshaft 11 having a first end and a second end, the first end connected to the flywheel 14 and the second end connected to the electric generator 16, an electrical outlet 20 disposed on an external sidewall of the housing, and a battery 22 operably connected to the electric generator 16, the pump 13 and the electrical outlet 20.

In one embodiment of the portable hydroelectric generator 10, the flywheel 14 is sufficiently massive that it once it has reached a threshold rotational speed, it requires minimal additional force to maintain that rotational speed. This minimal additional force is provided from the liquid stream exiting the pump 13. The pump 13 is placed at the bottom of the housing 12 and configured to move liquid from the bottom of the housing to a position sufficiently near the flywheel blades 15 to enable the output stream of liquid from the pump to apply a force to the flywheel blades 15, causing the flywheel 14 to continue to rotate. In one embodiment of the invention, the stream of liquid travels through piping 25 that runs from the pump to an output port 26 positioned in close proximity of the flywheel blades 15. The driveshaft 11 is connected both to the flywheel 14 and the electric generator 16, transferring the rotational movement from the flywheel to the electric generator 16. This rotation powers the electric generator 16, enabling the production of electricity.

In one embodiment of the portable hydroelectric generator, the generated electricity flows directly to the electrical outlet 20. The electrical outlet is configured to provide power in a similar manner as a traditional household outlet, such as a North American 120 volt outlet. In an alternative embodiment, the generated electricity flows to the battery 22 within the housing where it is stored. The battery 22 is operably connected to the generator 16, the electrical outlet 20, and the pump 13. A portion of the stored electricity in the battery is used to power the pump 13 and another portion of the stored electricity is used to provide power to the electrical outlet 20. The electronics of the portable hydroelectric generator, such as the battery, the pump, the outlet and all electric connection between these components are configured to be fully waterproof.

The housing 12 is configured to contain and be partially filled with a liquid such as water. Alternatively, the housing can be filled with a liquid mixture, such as water and an antifreeze agent, which can ensure that the portable hydroelectric generator continues to function in below-freezing temperatures. In order to easily fill the housing 12, an aperture 17 is placed on an exterior sidewall of the housing. The aperture 17 can be configured to be connectable to a commonly used source of water. For example, the aperture 17 can be equipped with a threaded collar that is adapted to fit the end of a commonly available garden hose. Additionally, a second aperture 18 can be placed at a lower position on a sidewall of the housing 12 to facilitate draining the liquid therein, making the portably electric generator easier to carry. Each apertures is sealed with a removable plug when not in use.

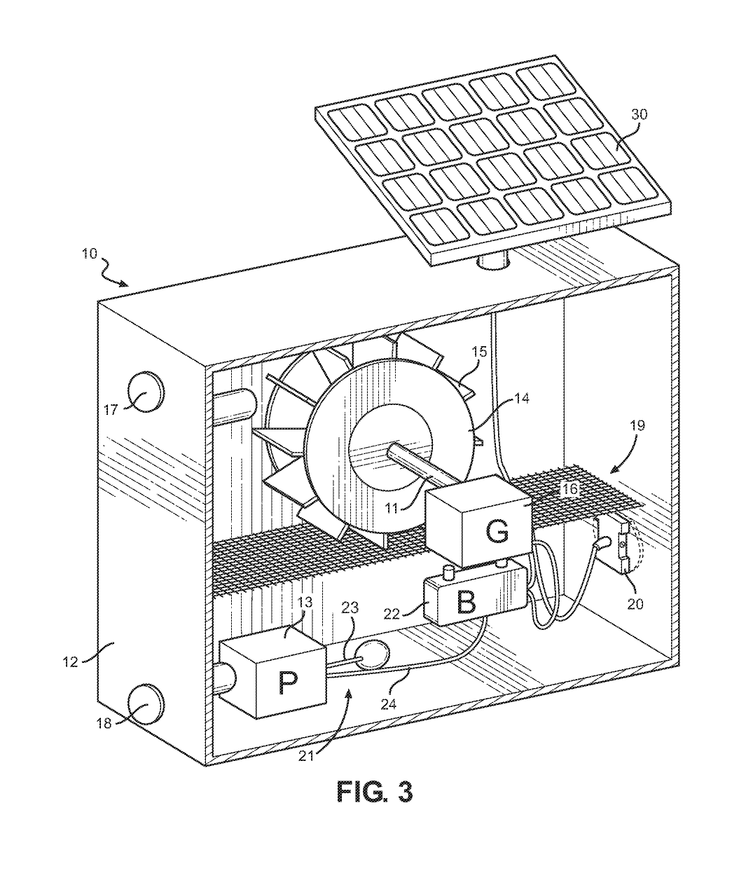

Referring now to FIG. 3, there is shown an alternative embodiment of the portable hydroelectric generator. A solar panel 30 known in the prior art is disposed on the housing and operably connected to the battery 22. The additional energy stored in the battery 22 from the solar panel 30 can be used to power the initial rotation of the flywheel 14 from a state of rest. Furthermore, the solar panel 30 can provide a supplemental source of electricity accessible to the electrical outlet.

The portable hydroelectric generator can include additional elements to ensure the most efficient flow of liquid within the housing. In one embodiment, the housing 12 additionally comprises a permeable barrier 19 disposed horizontally within the housing 12 and beneath the flywheel 14. The permeable barrier 19 is configured to prevent the backflow of liquid from the lower part of the housing 12 which may interfere with the rotational movement of the flywheel 14. In another embodiment, a gauge 21 is disposed within the housing to measure the water level. The gauge 21 is operably connected to pump 16 and comprises an elongated member 23 with a buoyant element 24. When the water level drops below a predetermined amount, the member 23 disengages the pump, safeguarding the pump 16 from operating with too little liquid in the housing.

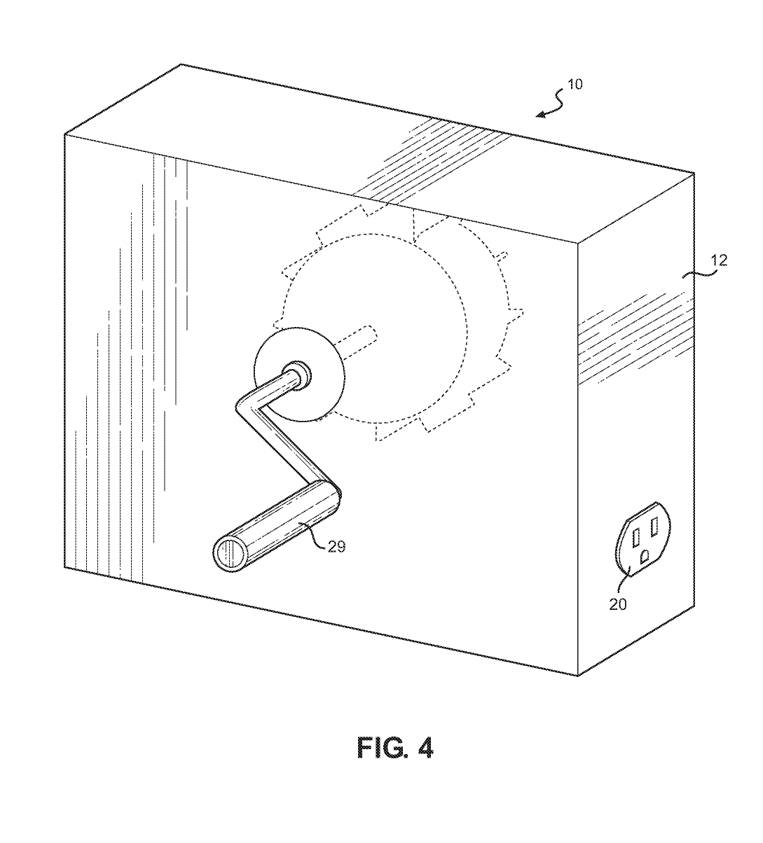

Referring now to FIG. 4, there is shown a rear perspective view of an alternative embodiment of the portable hydroelectric generator 10 wherein there is a manual lever 29 disposed on an exterior sidewall of the housing 12. The manual lever 29 is operably connected to the flywheel 14 through an opening in the sidewall. When manual rotational force is applied to the manual lever 29, the flywheel can be accelerated to a threshold rotational speed, such that the force from pump allows the flywheel to maintain its angular momentum and rotational speed. This manual lever is useful in increasing the rotational speed of a heavy flywheel, which requires a significant amount of force to begin rotating from rest.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable hydroelectric generator, comprising:
a housing having an interior volume, wherein the interior volume is adapted to receive a volume of liquid therein;
a pump disposed in the interior of the housing, the pump having an input port and an output port;
a flywheel comprising a central wheel and a plurality of blades extending from the central wheel, wherein the flywheel is mounted inside the interior of the housing and is positioned such the output port of the pump is aligned with the blades of the flywheel;
an electric generator disposed in the interior of the housing;
a driveshaft having a first end and a second end, the first end operably connected to the flywheel and the second end operably connected to the electric generator, wherein the driveshaft transfers rotational motion from the flywheel to the electric generator;
an outlet disposed on the housing.

2) The portable hydroelectric generator of claim 1, further comprising a battery operably connected to the pump and the outlet.

3) The portable hydroelectric generator of claim 1, further comprising tubing having a first end and a second end, wherein the first end is operably connected to the pump and the second end comprises the output port positioned near the blades of the flywheel.

4) The portable hydroelectric generator of claim 1, further comprising an aperture disposed on the sidewall of the housing, the aperture configured to be connectable to a water source.

5) The portable hydroelectric generator of claim 3, further comprising a second aperture disposed on the sidewall of the housing, the second aperture configured to drain liquid from within the housing.

6) The portable hydroelectric generator of claim 1, further comprising a solar panel, wherein the solar panel is operably connected to the battery.

7) The portable hydroelectric generator of claim 1, further comprising a liquid level indicator.

8) The portable hydroelectric generator of claim 4, wherein the liquid level indicator comprises an elongated member engaged with the pump and a buoyant member, configured to raise the elongated member when the level of liquid within the housing increases.

9) The portable hydroelectric generator of claim 1, further comprising a manual lever disposed on the exterior of the housing and connected to the flywheel, configured to rotate the flywheel.

10) The portable hydroelectric generator of claim 1, further comprising a permeable barrier disposed in the interior of the housing below the flywheel, configured to minimize currents with undesirable effects on the flywheel.
